(19) United States
(12) Patent Application Publication
(10) Pub. No.: US 2003/0115335 A1
(43) Pub. Date: Jun. 19, 2003

(54) Service provision system

(76) Inventors: Taku Yoshida, Fukuoka (JP); Hideo Ueno, Fukuoka (JP); Hiroyuki Tominaga, Fukuoka (JP); Toshihiro Ide, Fukuoka (JP)

Correspondence Address: KATTEN MUCHIN ZAVIS ROSENMAN, 575 MADISON AVENUE, NEW YORK, NY, 10022-2585, US

(21) Appl. No.: 09/968,441

(22) Filed: Oct. 1, 2001

(30) Foreign Application Priority Data
May 25, 2001 (JP) 2001-157034

(51) Int. Cl. G06F 15/16

(52) U.S. Cl. 709/228

(57) ABSTRACT

A voice communications request from a calling party is received by the access reception unit of a gatekeeper and is transferred to an access management unit. The access management unit judges whether the utilization registration of the terminal of a called party is made by referring to an address conversion unit, a utilization registration management unit and a user profile information management unit, and if the utilization registration is not made, the access management unit makes a service selection unit select a service. The selected service is provided by a service start unit through an IP application service provision unit or a call control service provision unit, and the provision of the service is reported to the calling party by a service provision information notification unit. By this service, the called user can know that there has been an incoming call from the calling party in some way.

### BACKGROUND OF THE INVENTION

1 . Field of the Invention

The present invention relates to a service provision system in voice communications using a network, such as an IP network and the like.

2 . Description of the Related Art

Today, as a result of the spread of the Internet, there has been a move to implement voice communications that are conducted using the line of a conventional circuit switching system in the Internet. The Internet is a type of a network generally called an IP network. The implementation of a VoIP service, which is a service for providing voice communications in this IP network, is being promoted.

In such an IP network for implementing voice communications, the phone number of a called party that a user inputs from a terminal, such as a telephone set, a personal computer and the like, must be converted into an IP address. It is a gatekeeper that plays this role.

FIG. 1 shows the basic configuration of a communications system for conducting voice communications using an IP network through a gatekeeper. In FIG. 1, a terminal is used to for a user to conduct voice communications. Identification information for specifying a called party, such as a phone number and the like, inputted from the terminal, is transmitted to the gatekeeper. After the identification information is converted into an IP address, voice data are transmitted to the terminal of the called party in a form of an IP packet.

FIG. 2 shows the basic configuration of a conventional gatekeeper.

The gatekeeper comprises an access reception unit 1 for receiving an access from a user, an access reply unit 2 for replying to an access from a user, a control message notification unit 3 for issuing a request to a user, a user profile information management unit 10 for managing the profile information of a user and a call management unit 9 for managing calls.

The access management unit 8 further comprises a an address conversion unit 4 for obtaining the address of a called party (for example, converting a phone number into an IP address), a utilization registration management unit 5 for registering the use start information of a user, a band management unit 6 for managing a band used to conduct communications and a call management/link unit 7 for managing call transmission/reception between users.

The user profile information management unit 10 registers the profiles of users entitled to receive a voice communications service when a user concludes an agreement to receive a voice communications service through an IP network and the like. The utilization registration management unit 5 judges whether a terminal used by a user entitled to receive a voice communications service is ready to conduct communications.

FIG. 3 is a sequence chart showing a procedure followed when a calling party with terminal X calls a called party with terminal Y.

In order to communicate, each of the calling and called parties must register the utilization of its own terminal in advance by performing a process shown in (A).

(A) A user accesses the gatekeeper from a terminal used to communicate to register its own utilization. The gatekeeper receives the access by the access reception unit 1. The utilization registration management unit 5 registers the address information of the relevant terminal by the user profile information management unit 10 and notifies the relevant terminal of the registration by the access reply unit 2.

When the calling party communicates with the called party, performs a process shown in (B).

(B) The calling party requests the gatekeeper for the address information of the called party from the terminal X. The gatekeeper receives the request by the access reception unit 1, obtains the address information of the terminal Y by the user profile information management unit 10 through the address conversion unit 4 if the access management unit 8 and notifies the terminal X of the address information of the terminal Y by the access reply unit 2.

Upon receipt of the address information of the terminal Y from the gatekeeper, the terminal X transmits a communications start request directed to the terminal Y to the gatekeeper. The gatekeeper receives the request by the access reception unit 1 and notifies the terminal Y of the communications start request through the call management/link unit 7, call management unit 9 and control message notification unit 3.

In response to the communications start request, the terminal Y transmits a call-up completion notice the gatekeeper. The gatekeeper receives the call-up completion notice by the access reception unit 1 and notifies the terminal X of the reception through the call management/link unit 7, call management unit 9 and control message notification unit 3.

When the called party replies, the terminal Y transmits a reply operation notice to the gatekeeper. The gatekeeper receives the reply operation notice by the access reception unit 1 and notifies the terminal X of the reply operation notice from the terminal Y through the call management/link unit 7, call management unit 9 and control message notification unit 3.

In this way, communications between the terminals X and Y are established.

In this case, if the called party has not performed the process (A), in the process (B) the called party cannot obtain the address information of the terminal Y, and the communications is not established. If the called party has not performed the process (A), a transfer service and the like is not also be executed.

Lately, it is not rare in an office that a personal computer connected to an IP network is assigned to each person, and the Internet is also rapidly spreading in homes. Thus, an environment for IP telephone is being prepared and an opportunity to use IP telephone will increase in the future.

IP telephone has an advantage that a call is made without a conventional telephone network nor a conventional telephone set and also has a disadvantage that if a called party has not performed the process (A), that is, the utilization registration in the gatekeeper, communications cannot be established between calling and called parties nor the called party can know that there has been a call request from a calling party.

Furthermore, since for a terminal to be used for IP telephone, not only a personal computer, but a TV set, a game machine for home and the like may also be used, a problem is anticipated to occur that communications cannot be conducted because the power of a terminal is switched off or the utilization is registered.

Thus, if communications cannot be conducted due to non-registration of the utilization registration information of a called party, the promotion of smooth communications after that process is effective.

### SUMMARY OF THE INVENTION

It is an object of the present invention to provide a service provision system for providing a user with carefully thought-out services.

The service provision system of the present invention is used to provide voice communications through a network. The service provision system compromises a utilization registration unit for registering utilization registration information for indicating that a terminal used to conduct voice communications is ready to conduct communications and a service provision unit for providing a service of notifying a called party of the fact that there has been a call for voice communications from a calling party if it is registered in the utilization registration unit that the terminal of the called party is not ready to conduct communications.

According to the present invention, even if a calling party fails to conduct voice communications with a called user, the utilization registration information required to conduct voice communications through a network of which is not registered, the fact that there has been a request for voice communications from the calling user can be reported to the called party, for example, by making a substitute respondent reply instead, notifying the called user of an incoming history, letting the called user know by e-mail that there has been a voice communications request from the calling and the like. Therefore, the problem that a calling party cannot communicate although the calling party has tried voice communications several times, can be prevented and a better voice communications service can be provided accordingly.

### BRIEF DESCRIPTION OF THE DRAWINGS

FIG. 1 shows the basic configuration of the communications system for conducting voice communications using an IP network through a gatekeeper;

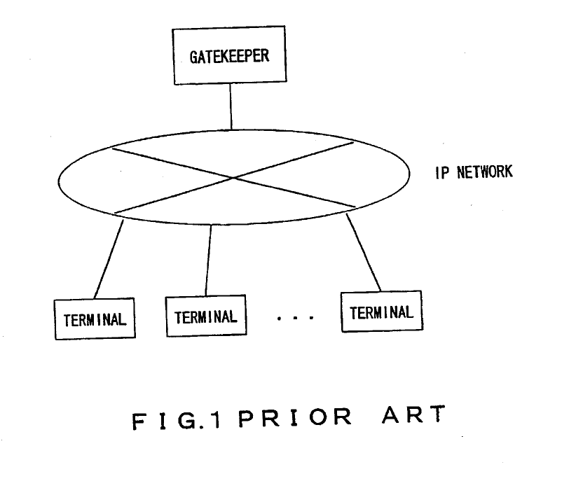

FIG. 2 shows the basic configuration of the conventional gatekeeper;

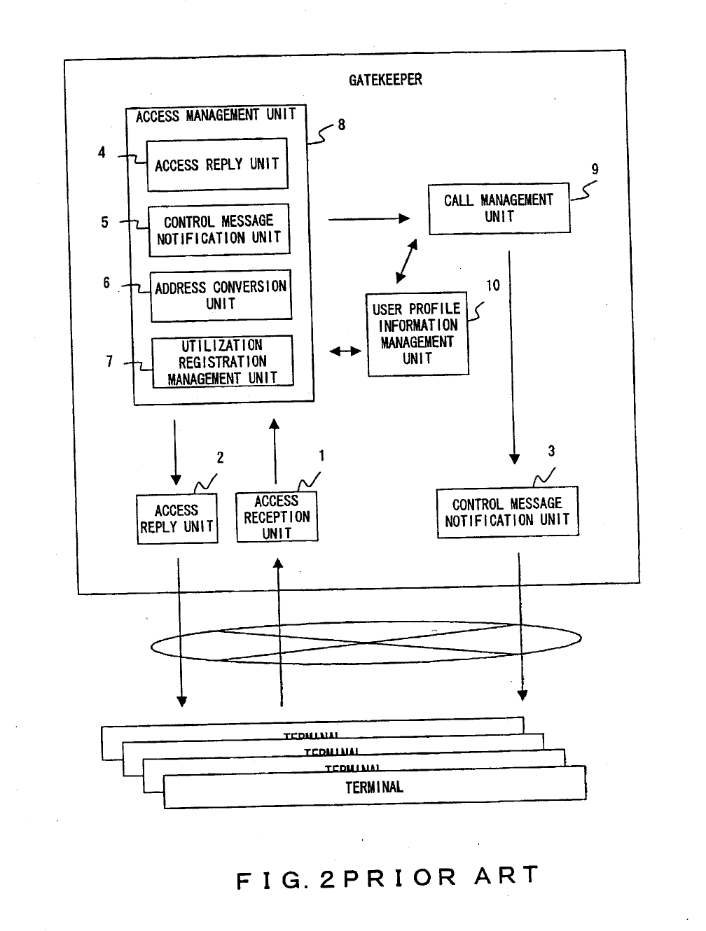

FIG. 3 is a sequence chart showing a procedure followed in the case where a calling party with terminal X calls a called party with terminal Y;

FIG. 4 shows a network environment to which the preferred embodiment of the present invention is applied;

FIG. 5 shows one configuration of the gatekeeper in the preferred embodiment of the present invention;

FIG. 6 is a sequence chart (No.1) showing the operation of the preferred embodiment;

FIG. 7 is a sequence chart (No.2) showing the operation of the preferred embodiment;

FIG. 8 is a sequence chart (No.3) showing the operation of the preferred embodiment;

FIG. 9 is a sequence chart (No.4) showing the operation of the preferred embodiment;

FIG. 10 is a sequence chart (No.5) showing the operation of the preferred embodiment;

FIG. 11 is a sequence chart (No.6) showing the operation of the preferred embodiment;

FIG. 12 shows the data structure managed by a user profile information management unit;

FIG. 13 shows one specific user profile;

FIG. 14 is a flowchart (No. 1) showing the process flow followed when a service is provided;

FIG. 15 is a flowchart (No. 2) showing the process flow followed when a service is provided;

FIG. 16 is a flowchart (No. 3) showing the process flow followed when a service is provided;

FIG. 17 is a flowchart (No. 4) showing the process flow followed when a service is provided;

FIG. 18 is a flowchart (No. 5) showing the process flow followed when a service is provided;

FIG. 19 is a flowchart (No. 6) showing the process flow followed when a service is provided;

FIG. 20 is a flowchart (No. 7) showing the process flow followed when a service is provided;

FIG. 21 is a flowchart (No. 8) showing the process flow followed when a service is provided.

### DESCRIPTION OF THE PREFERRED EMBODIMENTS

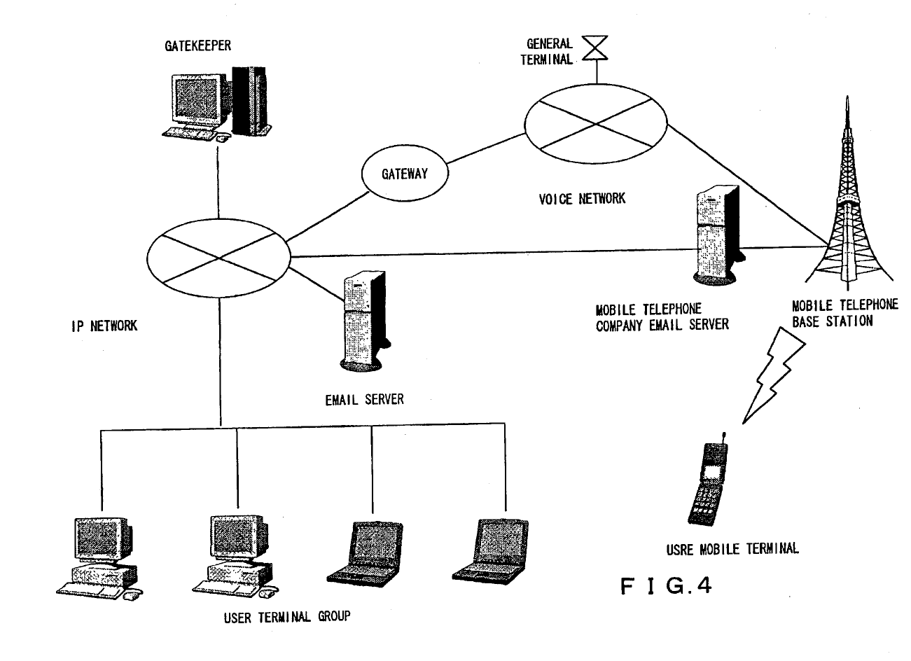

FIG. 4 shows a network environment to which the preferred embodiment is applied.

A group of user terminals. are connected to a gatekeeper, an email server, a gateway and the like through an IP network. For the user terminal group, an IP telephone, a game machine and other electronic equipment for home use with a communications function are used in addition to a personal computer. If the user terminal group communicates with another user terminal, a call originated from the user terminal group is received by the gatekeeper, the phone number of a called party is converted into an IP address as described earlier and the call is transmitted to the other user terminal. If the user terminal group calls an ordinary telephone terminal or a user mobile terminal that are connected to a voice network, a call originated from the user terminal group is received by the gatekeeper, the phone number of a called party is converted into an IP address and is transmitted to the ordinary telephone terminal or user mobile terminal through the gateway. Furthermore, the user terminal group calls each other through an email server connected to communicate or the email server of a mobile telephone company. The ordinary telephone terminal or user mobile terminal can also call the user terminal group. In this case, the gatekeeper receives an incoming call from the voice network through the gateway, the phone number of a called party is converted into an IP address and the call is transmitted to the user terminal group.

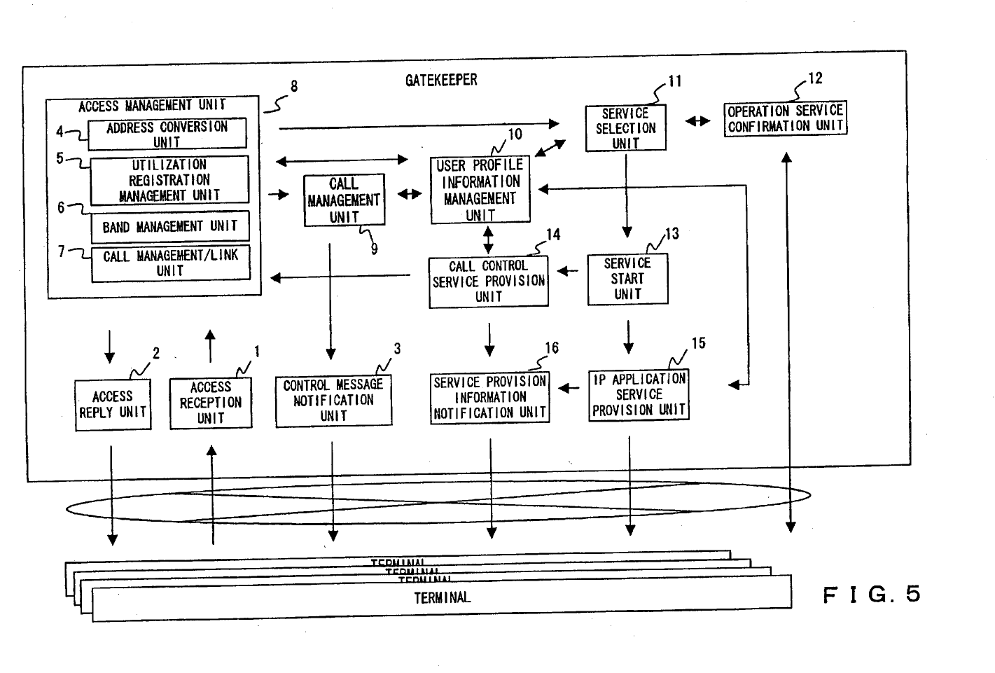

FIG. 5 shows one configuration of the gatekeeper in the preferred embodiment of the present invention.

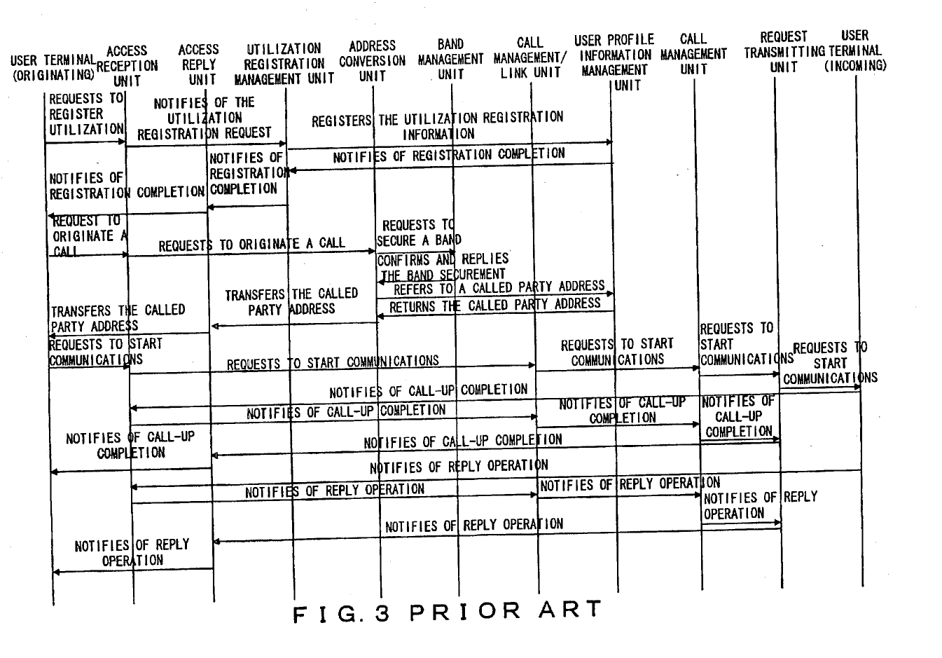

As described with reference to FIG. 3, in FIG. 5, an access reception unit 1 receives an access request from a user, an access reply unit 2 returns a message to the user and a control message notification unit 3 requests information about the user.

An access management unit 8 manages an access to a user, as described with reference to FIG. 3. A band management unit 6 and a call management/link unit 7 manage a band used to communicate and call transmission/reception between users, respectively. In this embodiment, both the address conversion unit 4 and utilization registration management unit 5 of the access management unit 8 add functions that are unavailable in the prior art.

Furthermore, although a call management unit 9 is the same as that of the prior art, a new function is added to a user profile information management unit 10. Simultaneously, a service selection unit 11, an operation service confirmation unit 12, a service start unit 13, a call control service provision unit 14, an IP application service provision unit 15 and a service provision information notification unit 16 are newly provided.

In particular, both the call control service provision unit 14 and IP application service provision unit 15 notify user B of the fact that there has been a call from user A to user B, for example, if user A communicates with user B using IP telephone but cannot communicate with user B because the terminal of user B is not ready to conduct communications.

For example, as call control services, there are a transfer service for connecting user A to the substitute of user B, a group call-up service for calling up one user of a group to which user B belongs, an ACD (Automatic call Distribution) call-up service, a message recording service and the like. As IP application services, there are e-mail, display on a Web browser, chat, an instant message and the like, notifying that there has been a call.

The service selection unit 11 selects a service to be provided from the plurality of services described above. The operation service confirmation unit 12 confirms the state of the target terminal of service provision. The service start unit 13 starts a selected service, and the service provision information notification unit 16 notifies user A or B of service provision in the above example.

The operation of the preferred embodiment is described in detail below with reference to the sequence charts.

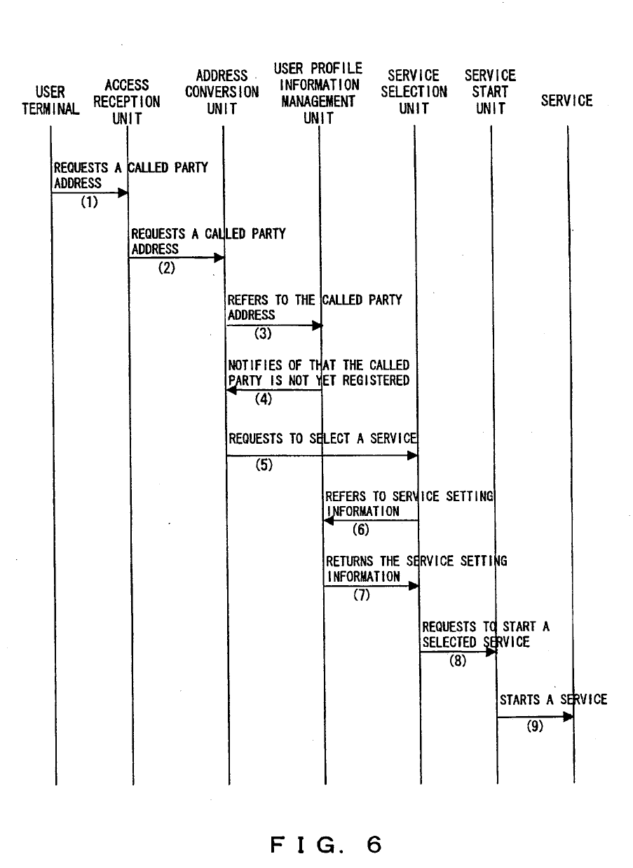

FIGS. 6 through 11 are sequence charts showing the operation of the preferred embodiment.

First, in FIG. 6, a user requests the gatekeeper for called-party address information from a user terminal (1), and the access reception unit requests the address conversion unit for the called-party address information (2). The address conversion unit refers to the called party address information of the user profile information management unit (3) and if the utilization registration of the called user is not yet made because the terminal of the called party is not ready to communicate and the like, the unit notifies the address conversion unit of the fact that the utilization start registration of the called user is not made (4). Although conventionally, the process is terminated in this stage, in the preferred embodiment, the following processes are further performed. Specifically, the address conversion unit requests the service selection unit to select a service (5). Then, the service selection unit refers to the service designation information (service time zone designation information, service priority information) of the user profile information management unit (6). Then, the user profile information management unit returns the service designation information to the service selection unit (7). Then, the service selection unit requests the service start unit to start the selected service (8). Then, the service start unit starts a service (9).

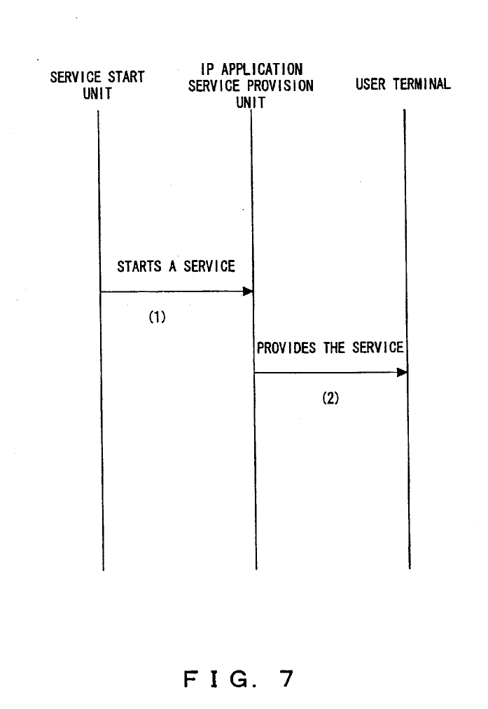

FIG. 7 is a sequence chart showing the process followed in the case where the service start unit provides a user terminal with an IP application service. The procedure until immediately before a service is provided is the same as that shown in FIG. 6. First, the service start unit starts the IP application service provision unit (1). Then, the IP application service provision unit provides a service target terminal with an IP application service (2).

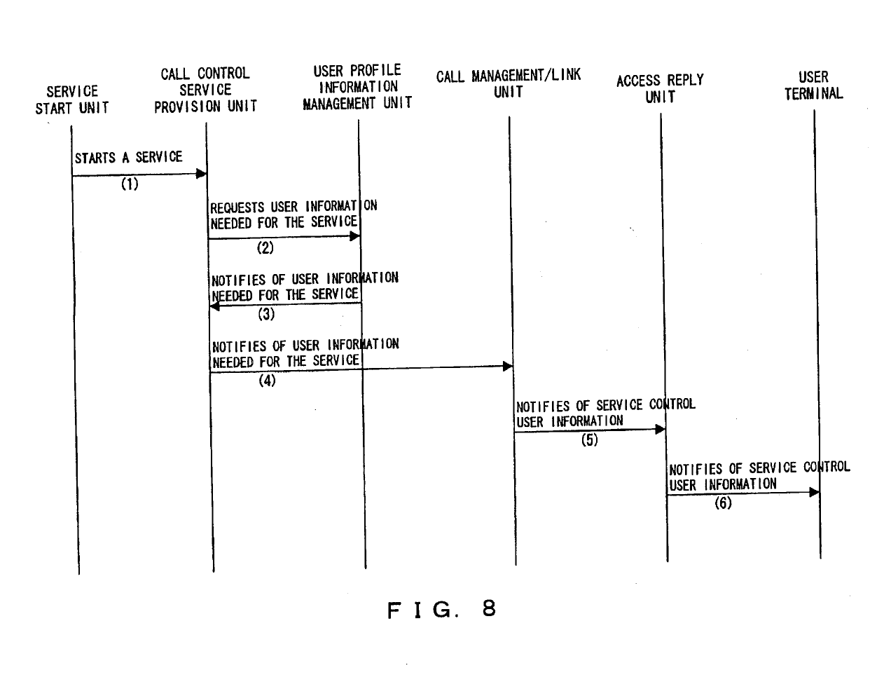

FIG. 8 is a sequence chart showing the process followed in the case where the service start unit provides a user terminal with a call control service. The procedure until immediately before a service is provided is the same as that shown in FIG. 6.

First, the service start unit activates the call control service provision unit (1). Then, the call control service provision unit requests the user profile information management unit for user information required to provide a call control service (2). Then, the user profile information management unit returns the requested user information to the call control service provision unit (3). Then, the call control service provision unit notifies the call management/link unit of the user information (4). Then, the call management/link unit of the user information transfers service control user information to the access reply unit (5). Then, the access reply unit notifies the user terminal of the service control user information (6).

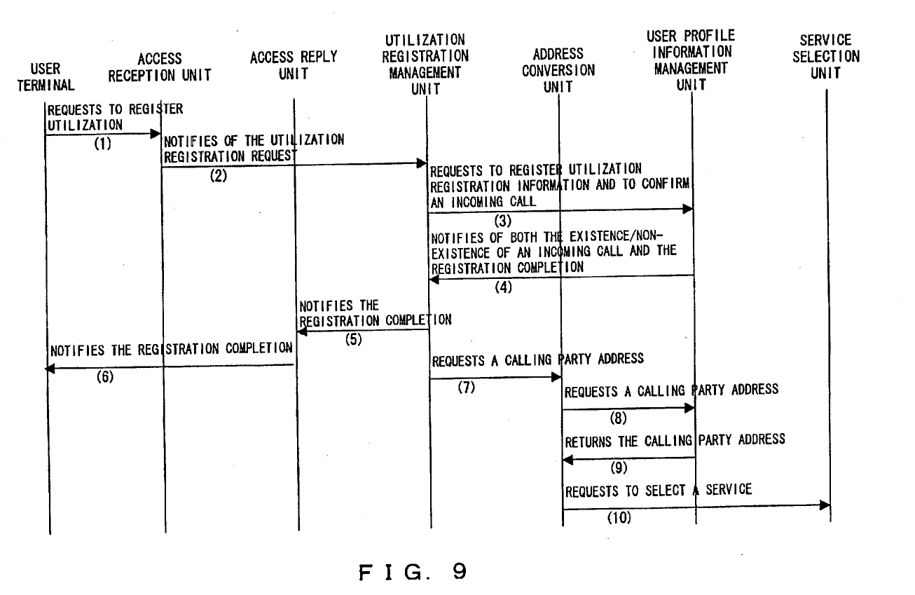

FIG. 9 is a sequence chart showing the process followed in the case where if a user makes utilization registration in the gatekeeper, the user is notified of whether there has been voice communications to the user while the utilization registration of the user has not been made.

A user that makes utilization registration accesses the gatekeeper and the gatekeeper receives the access by the access reception unit (1). Then, the access reception unit notifies the user registration management unit of a utilization registration request (2). Then, the user registration management unit makes an inquiry for whether there has been the utilization registration request of the user or there has been an incoming call to the user while the user is not yet registered to the user profile information management unit (3). Then, the user profile information management unit notifies the utilization registration management unit of both the completion of the utilization registration and the existence/non-existence of an incoming call (4). Then, the utilization registration management unit notifies the user terminal of the registration completion through the access reply unit (5) and (6). The utilization registration management unit requests the address conversion unit for the address of a calling party (7). Then, the address conversion unit requests the user profile information management unit for the calling party address (8). Then, the user profile information management unit returns the user profile information management unit to the address conversion unit (9). Then, the address conversion unit requests the service selection unit to select a service (10). Then, the service selection unit provides the user with a service in the same procedure as that in (6) and after of FIG. 6.

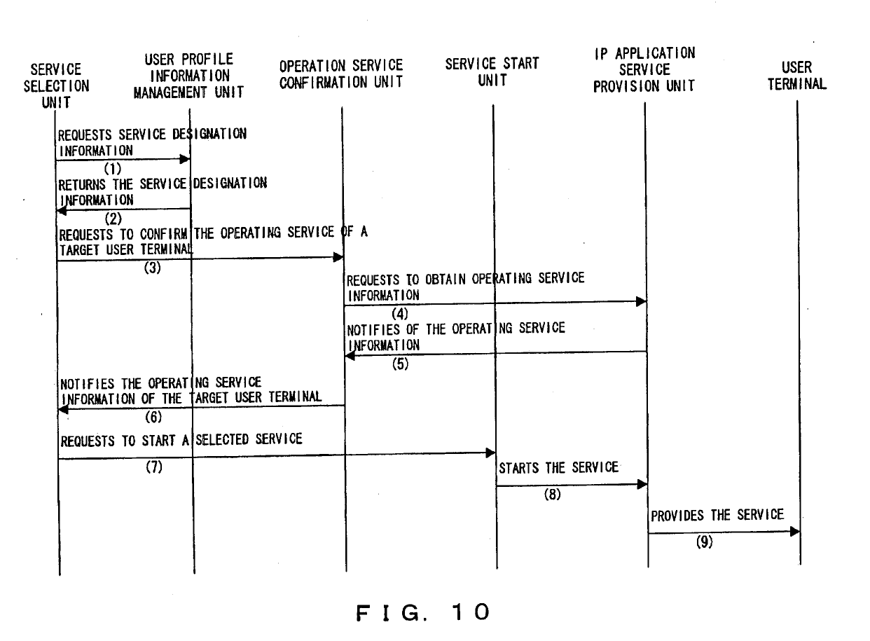

FIG. 10 is a sequence chart showing the process of obtaining the state of a terminal that receives a service and providing an appropriate service depending on the state.

The procedure until immediately before a service is selected is the same as that shown in FIG. 6.

The service selection unit requests the user profile information management unit for service designation information (1) . Then, the user profile information management unit returns the service designation information to the service selection unit (2). Then, the service selection unit requests the operation service confirmation unit for the operating service confirmation request of a user terminal, which is the target of service provision, (3). Then, the operation service confirmation unit requests the target user terminal to obtain operating service information (4). Then, the target user terminal notifies the operation service confirmation unit of the operating-service information (5). Then, the operation service confirmation unit notifies the service selection unit of the operating service information (6). Then, the service selection unit requests the service start unit to start the selected service (7). Then, the service start unit requests the IP application service provision unit to start the selected service (8). Then, the IP application service provision unit provides the target user terminal with the service (9).

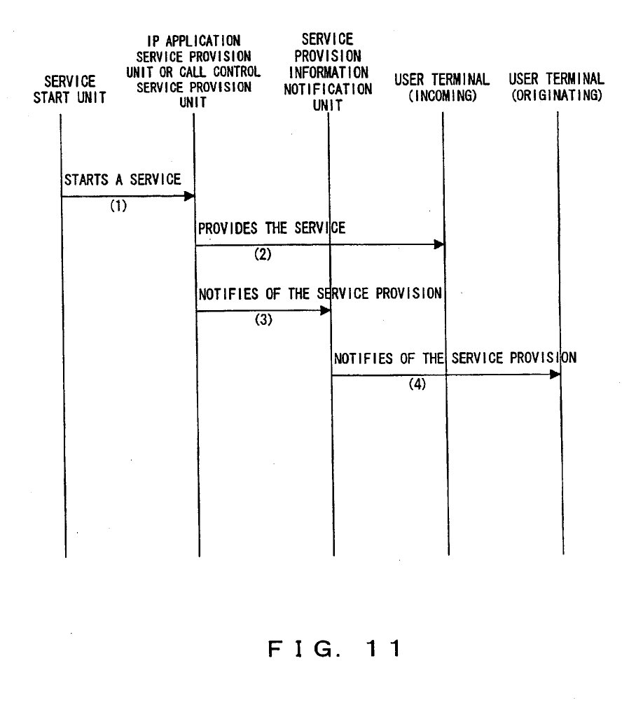

FIG. 11 is a sequence chart showing the process of notifying a calling user of service provision.

The procedure until immediately before a service is started is the same as that shown in FIG. 6.

The service start unit starts the IP application provision unit/call control service provision unit (1) Then, the IP application provision unit /call control service provision unit provide the user terminal of a called party with a service (2), and notifies the service provision information notification unit of provided service information (3). Then, the service provision information notification unit notifies the user terminal of a calling party of service provision information (4).

In this preferred embodiment, a time zone for providing a service can also be designated or service priority can also set.

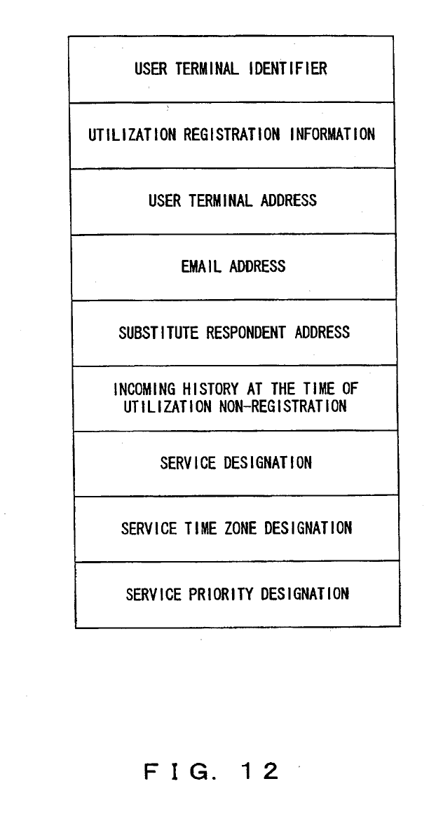

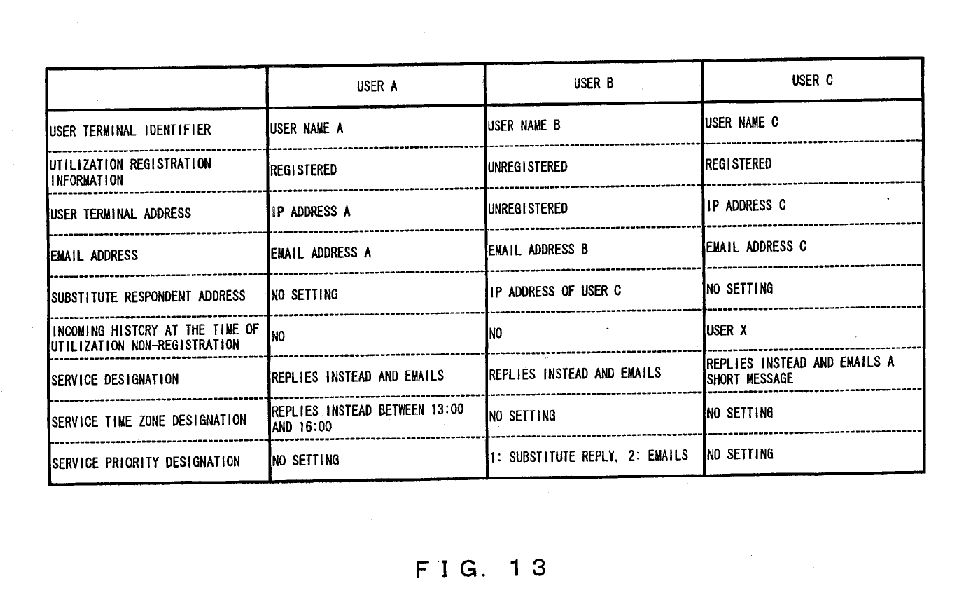

FIG. 12 shows a data structure managed by the user profile information management unit. FIG. 13 shows a specific example of a user profile.

The user profile sets a user identifier, which is the identification information of a user, utilization registration information, which is the utilization registration information of a user, a user terminal address, which the IP address of a terminal used by a user, the email address of the user, a substitute respondent address, which is a telephone transfer destination address used when a user is absent, an incoming call history before utilization registration is made, which is an incoming call history while utilization registration is not made, service designation, which is the service designation information provided by the gatekeeper, service time zone designation, which is service time zone designation, service priority designation, which is priority designation used when a plurality of services are provided.

A series of flows until the gatekeeper provides a user with a service if user A calls user B using IP telephone from terminal A and if the utilization registration of user B is not made, is described below.

In this case, it is assumed that the user profile information management unit has a user profile information database with the configuration shown in FIG. 12 and that a specific example is as shown in FIG. 13. The specific service to be provided is assumed to be each of the services described earlier.

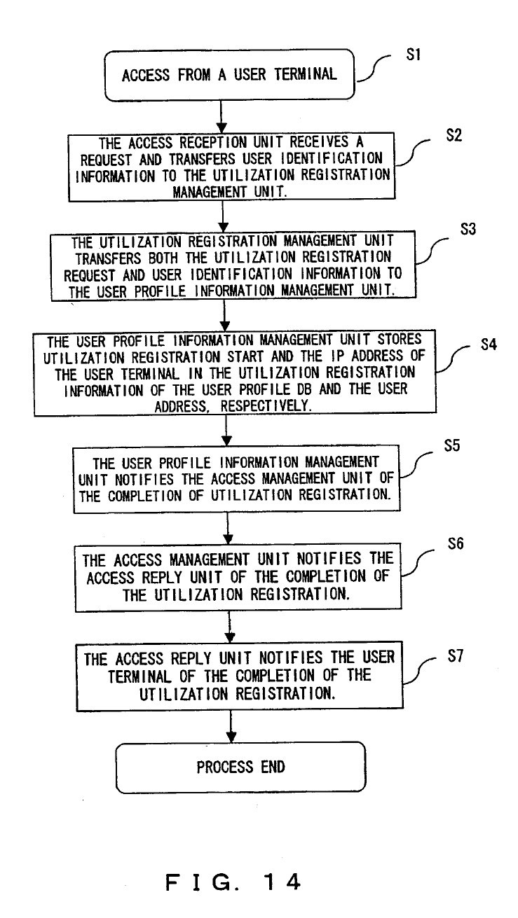

FIGS. 14 through 21 are flowcharts showing the process flow followed when a service is provided.

FIG. 14 is a flowchart showing the user A's process of utilization registration.

User A accesses the gatekeeper from terminal A (step S1). This access is automatically made when terminal A is started. The gatekeeper receives this access by the access reception unit and transfers the information to the utilization registration management unit (step S2). Then, the utilization registration management unit requests the user profile information management unit for the utilization registration of user A (step S3). Then, the user profile information management unit makes the utilization registration of utilization registration information user A of the user profile information database (step S4). Specifically, the user profile information management unit has the utilization registration information shown in FIG. 13 registered and records the IP address of a user terminal to be used for a user terminal address. When the utilization registration is completed, the user profile information management unit notifies terminal A of the utilization registration completion by the access reply unit through the access management unit (steps S5, 56 and S7).

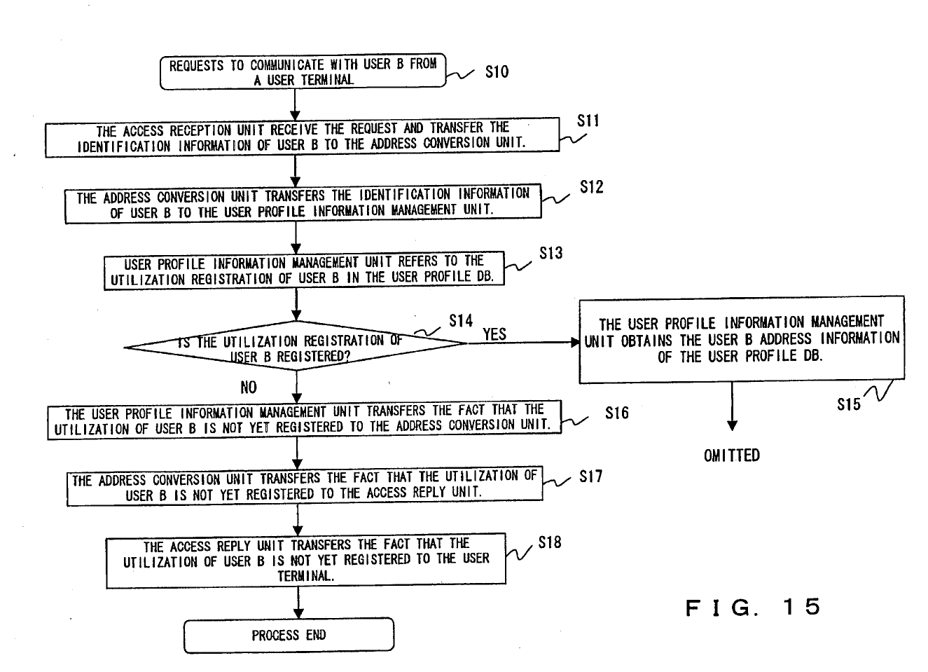

FIG. 15 is a flowchart showing the process of a communications request.

User A transmits a communications request to user B, which is a communications target, to the gatekeeper (step S10). Then, the gatekeeper receives the request by the access reception unit and transfers the information to the address conversion unit (step S11) Then, the user profile information management unit transmits the identifier of user B to the user profile information management unit and requests the user profile information management unit for corresponding address information (step S12). Then, the. user profile information management unit refers to the data user B of the user profile information database (step S13) and judges whether the utilization registration is made (step S 14). If the utilization registration is not made, user profile information management unit notifies the address conversion unit of the fact that the address information cannot be obtained because the utilization registration is not made (step S16). Then, the address conversion unit notifies terminal A of the fact that user B is not registered and communications is unavailable, by the access reply unit (step S17 and S18).

If in step S14 it is judged that user B is already registered, in step S15 the user profile information management unit obtains the address information of user B in the user profile database and starts communications. Since this procedure is the same as the conventional procedure, the flowchart is omitted.

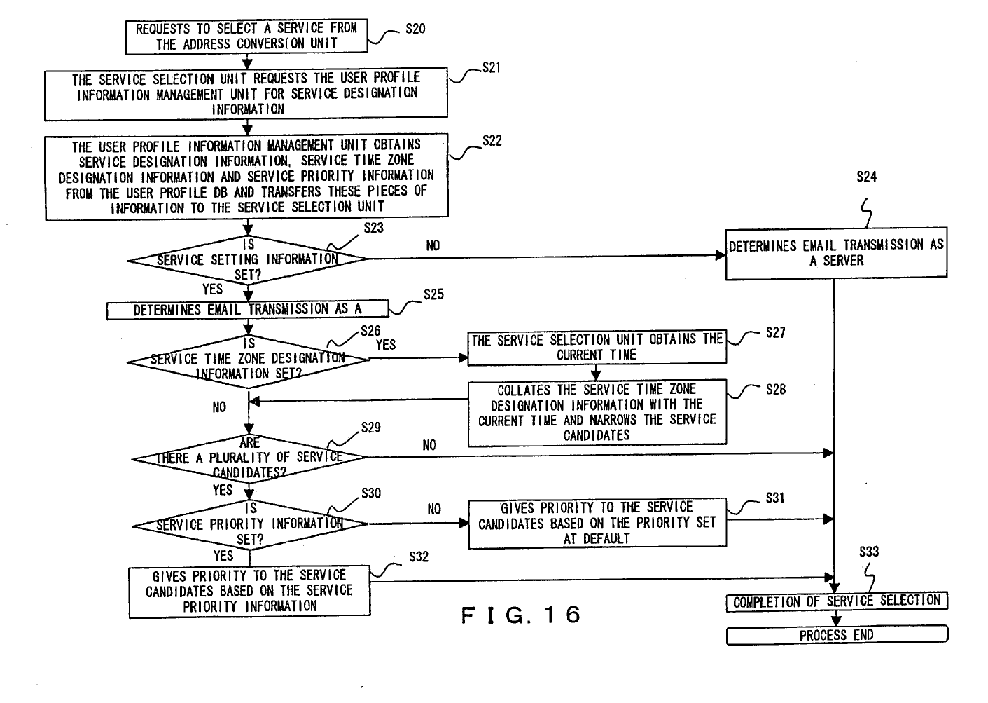

FIG. 16 is a flowchart showing process flow of a service request.

The address conversion unit requests the service selection unit to select a service (step S20). Then, the service user profile information management unit requests the user profile information management unit for service designation information (step S21). Then, the user profile information management unit refers to the user profile information database, obtains service designation information, service start priority designation information and service time zone designation information and transfers those pieces of information to the service selection unit (step S22) Then, the service selection unit determines a service based on those pieces of information.

First, the service selection unit judges whether service designation information is set (step S23). If the service designation information is not set, service is limited only to email transmission (steps S24 and S33).

If in step S23 it is judged that service designation information is set, designated one or a plurality of services become service candidates (step S25) . Then, it is judged whether service time zone designation information is set (step S26) . If the service time zone designation information is set, the information is referenced to the current time and the designated services become service candidates (steps S27 and S28) . If the service time zone designation information is not set, the service candidates are left unchanged.

In step S29, it is judged whether there are a plurality of service candidates. If there is only one candidate, the service selection unit selects the service and the selection is completed (step S33). If there are the plurality of service candidates, the service selection unit refers to service priority information and judges whether service priority information is set (step S30). If the service priority information is set, the service selection unit gives priority to the service candidates according to the information (step S32). If the service priority information is not set, the service selection unit gives priority to the service candidates based on the order at default (for example, 1: substitute-respondent transfer, 2: Web-browser message indication, 3: email transmission, etc.) (step S31).

Services are selected in the procedure describe above.

Next, the start of a service is described.

The service selection unit requests the service start unit to start a selected service.

Here, service contents are categorized into two groups: (a) a call control service and (b) an IP application service, and the case of each service is described below.

In the case of a call control service, service provision information is not reported to the original calling party. However, in the case of an IP application service, service provision information is reported to the original calling party.

(a) Call Control Service

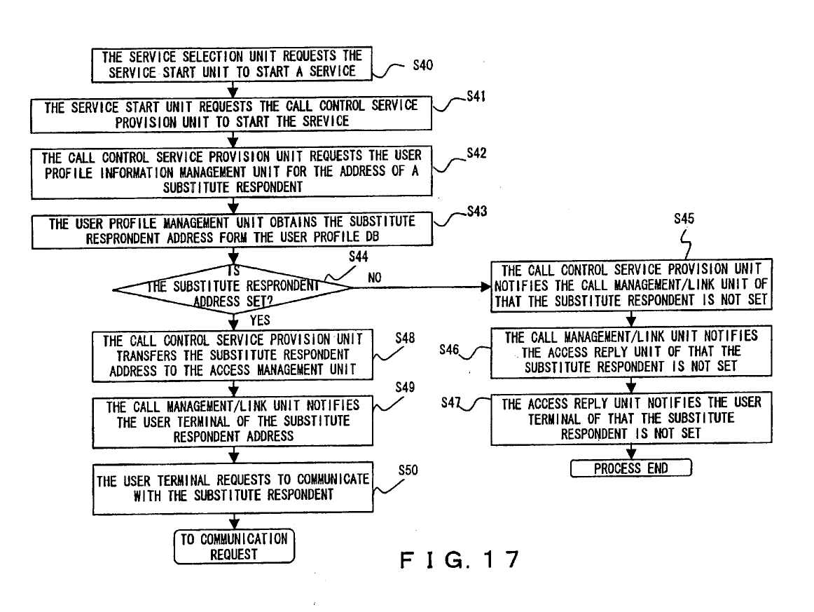

FIG. 17 is a flowchart showing the process of a call control service.

The service selection unit requests the service start unit to start a service (step S40). Then, the service start unit requests the call control service provision unit to start a service (step S41). Then, the call control service provision unit requests the user profile information management unit for the address of a substitute respondent (step S42) . Then, the user profile information management unit refers to the address of the substitute respondent in the user profile information database (step S43; specifically, it refers to the substitute respondent address of user B shown in FIG. 13).

Then, it is judged whether a substitute respondent address is set (step S44). If the substitute respondent address is set, the user profile information management unit transfers the substitute respondent address to the access management unit (step S48) and notifies a user terminal of the substitute respondent address through the access reply unit (step S49). Upon receipt of the notice, the user terminal makes a request to communicate with the substitute respondent (step S50). Then, a transfer service to the substitute respondent is implemented. Specifically, a transfer service to the substitute respondent is available by the user profile information management unit referring to the substitute respondent address of user B shown in FIG. 13 and notifying the terminal of user A of the IP address of user C, which is designated as the substitute respondent.

If in step S44 it is judged that the substitute respondent address is not set, the user profile information management unit notifies the user terminal of the non-setting of the substitute respondent through the access management unit and access reply unit (steps S45, S46 and S47) . In the case of a call control service, service provision information is not reported to the original calling party.

(b) IP Application Service

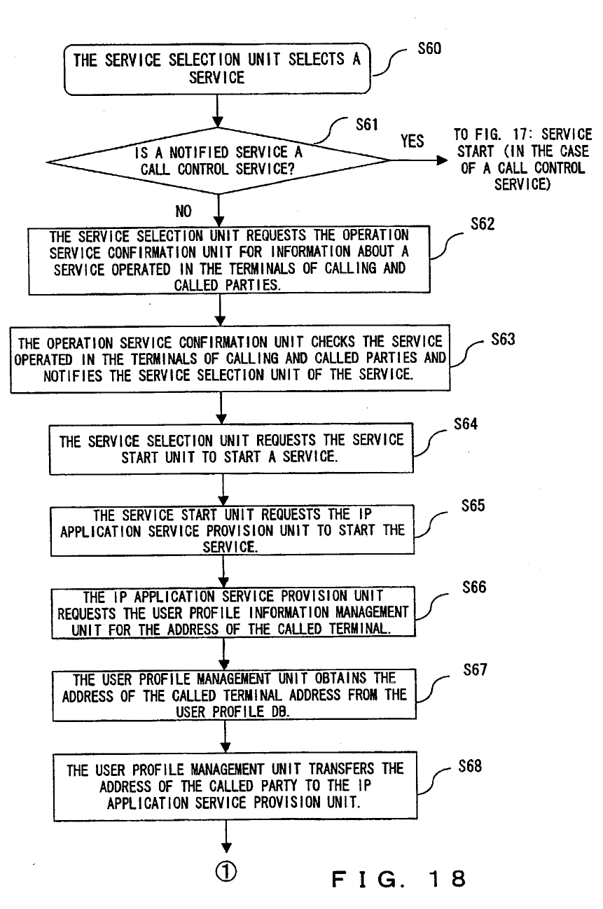

FIGS. 18 through 20 are flowcharts showing the provision process of an IP application service.

The service selection unit notifies the service start unit of a selected service (step S60). In step S61, the service selection unit judges whether the notified service is a call control service. If the service to be provided is a call control service, the service selection unit provides the call control service described in (a). If the service is not a call control service, that is, if the service is an IP application service, the service selection unit requests the operation service confirmation unit for information about a service that is operated in the terminals of both the calling and called parties (step S62).

The operation service confirmation unit checks the service that is operated in the terminals of both the calling and called parties and notifies the service selection unit of the result (step S63). Then, the service selection unit requests the service start unit to start a service (step S64) . Then, the service start unit requests the IP application service provision unit to start the service (step S65) . Then, the IP application service provision unit requests the user profile information management unit for the address of the terminal of the called party (step S66). Then, the user profile information management unit obtains the terminal address from the user profile information database and transfers the address to the IP application service provision unit (steps S67 and S68).

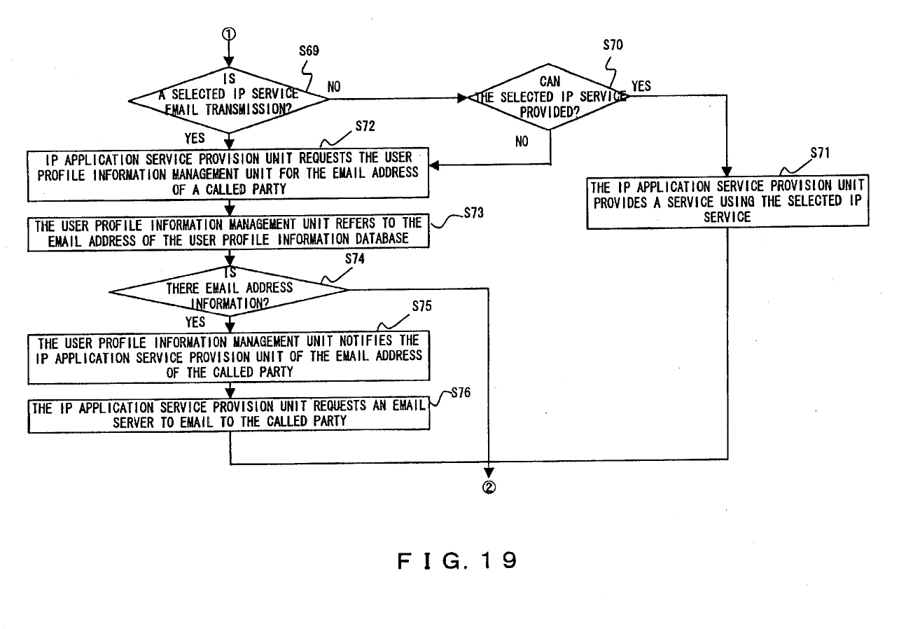

In step S69 (FIG. 19), it is judged whether a selected IP application service is email transmission. If the service to be provided is other than email transmission, it is further judged whether the service is available based on information confirmed by the operation service confirmation unit (step S70) If the service is available, the IP application service provision unit provides the service (step S71) . If the service is unavailable, email is used instead (no in step s70)

If the service is originally email (yes in step S69) and if email is used as the substitute means for another service (no in step S70), the IP application provision unit requests the user profile information management unit for the address of the called party (step S72) . Then, the user profile information management unit refers to the user profile information database (step S73).

Then, in step S74, the user profile information management unit judges whether there is email address information in the database. If there is no email address information, an email service is not provided (no in step S74). If there is the information (yes in step S74), the user profile information management unit notifies the IP application provision unit of the email address (step S75). Then, the IP application provision unit requests an email server to transmit email addressed to the called party (step S76).

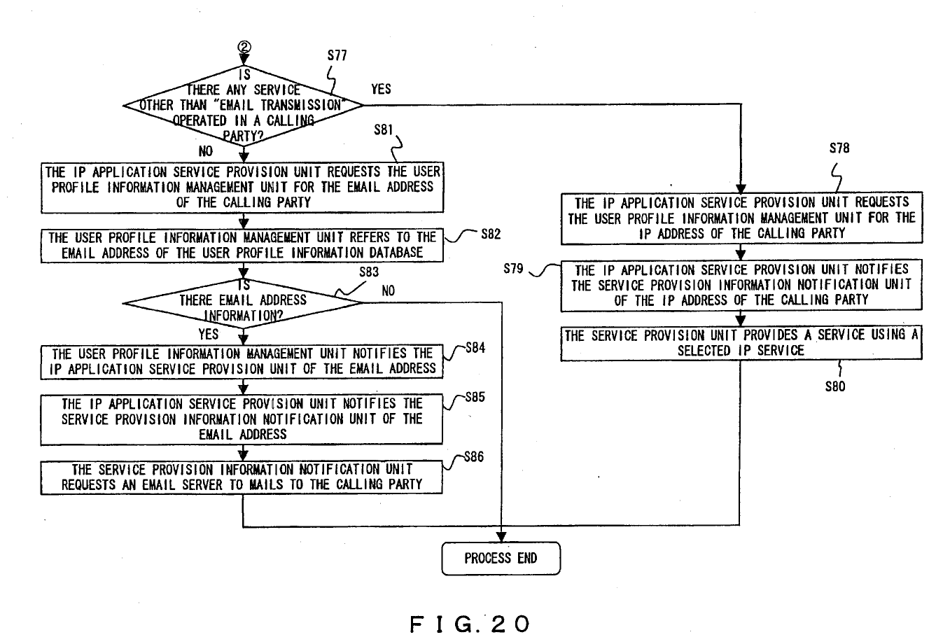

So far the service provision to a called party has been described. Service provision information notification to a calling party is described below (FIG. 20).

If the operation service confirmation unit checks whether a service other than email is operated in the terminal of a calling party (step S77) and as a result, a service other than email is operated in the terminal of the calling party (yes in step S77), the service provision information is reported to the calling party using the service. Specifically, the IP application service provision unit requests the user profile information management unit for the IP address of the calling party (step S78). Then, the user profile information management unit obtains the IP address of the calling party from the user profile information database and notifies the IP application service provision unit of the address (step S79). Then, the IP application service provision unit provides a service using a selected IP service (step SBO) and transfers the notified IP address to the service provision information notification unit. Then, the service provision information notification unit notifies the terminal of the calling party of the service provision information using the selected service and terminates the process.

If as a check result of the operation service confirmation unit (step S77), no service is operated in the terminal of the calling party (no in step S77), the service provision information is reported to the calling party by email. Specifically, the IP application service provision unit requests the user profile information management unit for the email address of the calling party (step S81). Then, the user profile information management unit refers to the email address of the calling party in the user profile information database (step S82). Then, the user profile information management unit judges whether there is email address information in the database (step S83). If there is no email address information (no in step S83), the user profile information management unit terminates the process. If there is the email address information (yes in step S83), the user profile information management unit notifies the IP application service provision unit of the email address (step S84) . The IP application service provision unit transfers the notified email address to the service provision information notification unit (step S85). Then, the service provision information notification unit requests the email server to transmit email addressed to the calling party (step S86) and terminates the process.

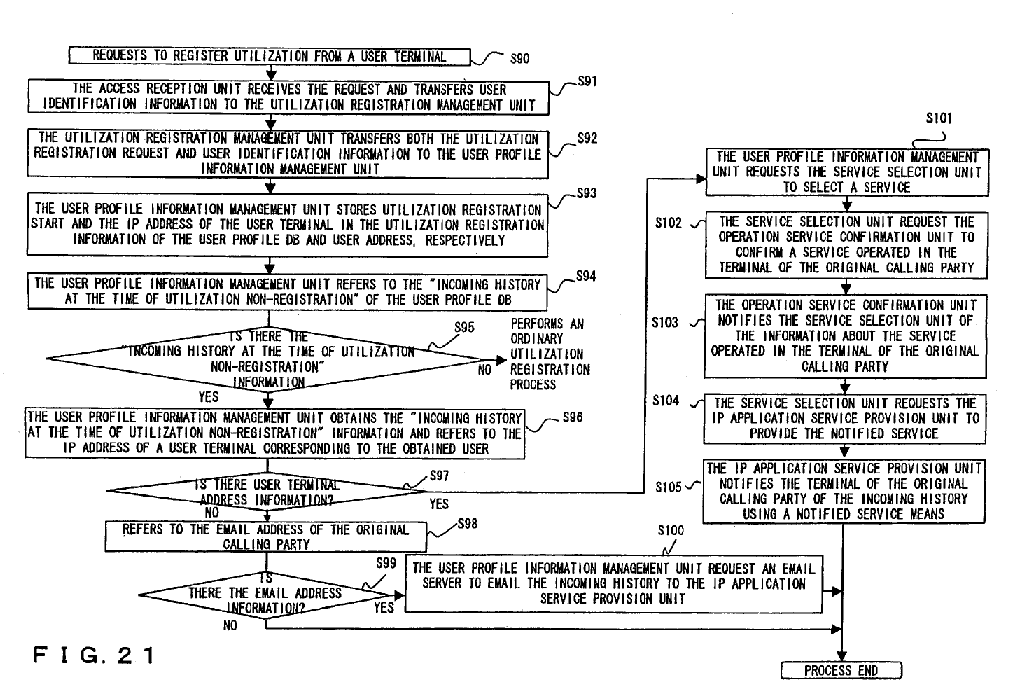

FIG. 21 is a flowchart showing an incoming history notification process at the time of utilization registration.

User A accesses the gatekeeper from terminal A and issues a utilization registration request (step S90) Then, the gatekeeper receives this access by the access reception unit and transfers the information to the utilization registration management unit (step S91). Then, the utilization registration management unit requests the user profile information management unit to make the utilization registration of user A. Then, the user profile information management unit makes the utilization registration of user A in the utilization registration information of the user profile information database (steps S92 and S93). In this case, the user profile information management unit refers to the incoming history of user A in the user profile information database (step S94) and checks whether there has been an incoming call while user A is not registered (step S95).

If there is no incoming history (no in step S95), the user profile information management unit performs an ordinary utilization registration process.

If there is an incoming history (yes in step S95), in addition to an ordinary utilization registration process, the user profile information management unit notifies user X that originates the call of the utilization registration of user A.

Although for the means, email, chat, a Web browser, a short message and the like are used, the means is determined by the judgment on the state of the terminal of user X of the operation service confirmation unit. If the power of the terminal of user X is switched off, email is used.

To use email, the user profile information management unit refers to the email address of the user profile information database (step S96). If there is the email address information, the user profile information management unit requests the email server to transmit email addressed to the email address. If there is no email address information, the user profile information management unit terminates the process.

Specifically, if the judgment in step S97 is no, in step S98 the user profile information management unit refers to the email address of the original calling party and in step S99 the unit judges whether there is the email address information. If the judgment in step S99 is no, the user profile information management unit terminates the process. If the judgment in step S99 is yes, in step S100 the user profile information management unit requests the IP application service provision unit to transmit email describing the incoming history and terminates the process.

If the judgment in step S97 is no, in step S101 the user profile information management unit requests the service selection unit to select a service. Then, in step S102, the service selection unit requests the operation service confirmation unit to confirm a service operated in the terminal of the original calling party. Then, in step S103, the operation service confirmation unit notifies the service selection unit of information about the service operating in the terminal of the original calling party, and in step S104, the service selection unit requests the IP application service provision unit to provide a notified service. Then, in step S105, the IP application service provision unit notifies the terminal of the original calling party of the incoming history by a notified service means and terminates the process.

Service Case

Users A, B and C are assumed.

User A is an employee of company X, and both users B and C are colleagues sitting together in company Y.

One day user B goes out on business from 10 to 15 o'clock. User B carries a cellular phone with him/her on the business trip. Before the trip, user B accesses the gatekeeper and sets service information in his/her user profile information in order to respond to IP telephone that might arrive while he/she is out of the office. As the registration method, he/she accesses the gatekeeper from his/her terminal. Alternatively, he/she can also ask the manager of the gatekeeper to do so.

User B designates user C as his/her substitute respondent and further sets so that an incoming history can be transmitted to his/her cellular phone by email while there is an incoming call while he/she is out. Time designation is also made in such a way that these services are available only from 10 to 15 o'clock.

On that day, user A calls user B at noon by IP telephone. User B goes out. Although the power of his/her terminal is not switched on, the call is transferred to user C in the next seat and user C can handle the business of user A. User B can know that there has been an IP telephone call from user A at noon by email transmitted over the cellular phone.

In the preferred embodiment described above, if a called user has not made his/her utilization registration, the called party can be notified of the existence of an incoming call in some way. Alternatively, when a called user has made his/her utilization registration, a calling party can also be notified of the utilization registration of the called party and the calling party can also call the called user again.

Even if in voice communications in a network, such as an IP network through a gatekeeper, communications cannot be established because a called user does not switch the power of the terminal on or has not started communication software, the present invention enables the gatekeeper to automatically start a service and provide a user with the service.

By using the notification of an incoming history by e-mail, message display on an IP application (Web browser, chat, short email, etc.) operated in the called party, transfer to a substitute respondent and the like for services to be provided, the called user that cannot receive a call can know that there has been an incoming call. By notifying a calling party of these pieces of service provision information, the calling and called users can also communicate smoothly.

Furthermore, by designating the time zone of a service group to be used or the execution priority of the service group, a user can enjoy comfortable services.

In an environment where IP telephone is used, it is anticipated that a state where communications are unavailable frequently occurs. However, by adopting the present invention, for example, even if the called user of IP telephone is out of the office or his/her home, or the terminal of a called party is not activated, smooth communications are available by notifying the portable data terminal of a called party, of the incoming history of the called party by email or transferring a call to another designated phone number.

What is claimed is:

1. A service provision system for providing voice communications through a network, comprising:
a utilization registration unit registering utilization registration information indicating that a voice communications terminal is ready to conduct voice communications; and
a service provision unit providing a service for notifying a called user of existence of a call for voice communications from a calling user if there is utilization registration information that a terminal of the called user is not ready to conduct voice communications.

2. The service provision system according to claim 1, wherein
said service provision unit provides a type of service based on designation of a user using voice communications.

3. The service provision system according to claim 1, further comprising
a state acquisition unit obtaining a state of the terminal of a called user, wherein
said service provision unit modifies a type of service to be provided depending on the state of the called user.

4. The service provision system according to claim 1, wherein
the network is an IP network.

5. The service provision system according to claim 1, further comprising
a service provision notification unit notifying a calling user of provision of a service if said service provision unit provides the service.

6. The service provision system according to claim 1, further comprising
designation information for designating a time zone where the service is provided or service priority according to which a plurality of types of services are provided, wherein
said service provision unit provides services in a designated time zone or according to priority based on the designation information.

7. The service provision system according to claim 1, wherein
said service provision unit notifies the called user of an incoming history recorded while utilization of the terminal is not registered through the terminal when utilization registration of a terminal of a called user is made.

8. The service provision system according to claim 1, wherein
said service provision unit connects a voice communications call from a calling user to a substitute respondent if utilization registration of the terminal of the called user is not made.

9. A service provision method in a service provision system for providing voice communications through a network, comprising:
registering utilization registration information indicating that a voice communications terminal is ready to conduct voice communications; and
providing a service for notifying a called user of existence of a call for voice communications from a calling user if there is utilization registration information indicating that a terminal of the called user is not ready to conduct voice communications.

10. The service provision method according to claim 9, wherein
in said service provision step, a type of service based on the designation of a user using voice communications.

11. The service provision method according to claim 9, further comprising
obtaining a state of a terminal of a called user, wherein
in said service provision step, a type of service to be provided is modified depending on the state of the terminal of the called user.

12. The service provision method according to claim 9, wherein
the network is an IP network.

13. The service provision method according to claim 9, further comprising
notifying a calling user of provision of a service if in said service provision step, the service is provided.

14. The service provision method according to claim 9, further comprising:
designating a time zone where the service is provided or a service priority according to which a plurality of types of services are provided, wherein
in said service provision step services are provided in a designated time zone or according to priority based on the designation information.

15. The service provision method according to claim 9, wherein
in said service provision step, the called user of an incoming history recorded while utilization registration of the terminal is not made is reported to the called user through the terminal when utilization registration of a terminal of a called user is made.

16. The service provision method according to claim 9,wherein
in said service provision step, a voice communications call from a calling user is connected to a substitute respondent if utilization registration of the terminal of the called user is not made.
